(19) United States
(12) Patent Application Publication
(10) Pub. No.: US 2016/0217270 A1
(43) Pub. Date: Jul. 28, 2016

(54) FACILITATING MEDICATION TREATMENT REGIMES

(71) Applicant: Ian FERGUSON, Toronto, CA (US)

(72) Inventor: Ian FERGUSON, Toronto, CA (US)

(21) Appl. No.: 15/002,762

(22) Filed: Jan. 21, 2016

Related U.S. Application Data
(60) Provisional application No. 62/108,215, filed on Jan. 27, 2015.

(51) Int. Cl. G06F 19/00; G06F 17/30

(52) U.S. Cl. CPC G06F 19/3456; G06F 17/30424

(57) ABSTRACT

Information is provided for patients and consumers, both in the pharmacy (in a shopping scenario) and within a home or a care facility. Triggered by the package itself, an executed application may display information about a medication and help patients and caregivers administer the medication properly using reminders and calendaring.

### CROSS-REFERENCE TO RELATED APPLICATIONS

The present application is a continuation application of U.S. Provisional Patent Application No. 62/108,215, filed Jan. 27, 2015, the contents of which are hereby incorporated herein by reference.

### FIELD

The present application relates generally to medication treatment regimes and, more specifically, to facilitating medication treatment regimes.

### BACKGROUND

A report, Aspden, P., Wolcott, J., Bootman, J. L., & Cronenwett, L. R. “Preventing Medication Errors: Quality Chasm Series”, Washington D.C.: National Academies Press, 2006, from the Committee on Identifying and Preventing Medication Errors of the Institute of Medicine of the National Academies (USA), states that there are 1.5 million preventable adverse drug reactions per year in the United States. Preventable adverse drug reactions in US hospitals alone are estimated to cost $3.5 billion per annum.

According to the report, many of these adverse drug reactions could be prevented through better pharmaceutical labels that communicate critical information in an easy-to-use manner and make it easier for patients, caregivers and prescribers to understand how to administer medications properly.

### BRIEF DESCRIPTION OF THE DRAWINGS

Reference will now be made, by way of example, to the accompanying drawings which show example implementations; and in which:

FIG. 1 illustrates a mobile communication device as an example of a device that may carry out methods representative of aspects of the present application;

FIG. 2 illustrates an environment in which elements that support aspects of the present application may interact;

FIG. 3 illustrates example steps in a method of facilitating medication treatment regimes in accordance with embodiments of the present application; and

FIG. 4 illustrates a display layout for facilitating medication treatment regimes in accordance with embodiments of the present application.

### DETAILED DESCRIPTION

Three key problems may be seen to affect patient compliance with medication treatment regimes. These problems include pharmaceutical package labels that may be considered, by some, to be confusing. These problems also include patients taking prescription or over-the-counter medications inappropriately. These problems further include poor patient adherence to a dosage schedule.

To meet regulatory requirements and to provide patients with dosage and safety information, pharmacies, when providing prescription medications, frequently include leaflets or multipage labels. Such leaflets or multipage labels are often crammed with a mass of confusing information. This information is unstructured data; patients must read large amounts of small type to see if a medication is unsuitable for them due to a medical condition, or to be aware of serious side effects. The information that can be displayed on a leaflet is a small subset of the information that a patient may need or want about the medication they are taking. Online databases like drugs.com contain a large amount of information for patients and caregivers, but there is no easy connection between the medication itself and the online database.

Patients, caregivers and prescribers complain that pharmaceutical packaging, leaflets and labels: are difficult to read; do a poor job of providing pre-purchase information in a store or in a pharmacy setting; do not integrate with patient's digital lives; and are unlikely to prioritize the information most important to a particular patient. The patient's digital life may be defined to include personal patient medical records. The patient's digital life may be defined to include applications executed on various ones of the patient's computing devices. Such applications may include a calendar application, which may be employed to provide the patient with medication dosage reminders. Such applications may also include a web browser application, which may be employed to provide detailed information about medications.

Many commonly-prescribed or purchased medications: are contraindicated for special populations like seniors or children and can cause serious side-effects in that population; can have serious side effects; trigger allergic reactions; cause complications in patients with certain pre-existing medical conditions or illnesses; and conflict with medications the patient is already taking (i.e., the patient's GP prescribes a new medication that conflicts with medication the patient is already taking, perhaps prescribed by a different physician).

Patients who forget to take their medication or forget to renew their prescriptions are leaving their medical problem untreated. In addition, some patients take their medication the wrong way (i.e., with food when the medication should be taken on an empty stomach).

It is proposed herein to provide information to a patient in an easy-to-read digital format. Such information may be presented in a manner that alleviates at least some of the confusion that may be associated with current medication labeling. The information may further warn a patient about potentially harmful medication interactions. Additionally, various triggers may assist the patient toward better adherence to medication dosage schedules.

According to an aspect of the present disclosure, there is provided a method of facilitating, at a device, a regime for administering of a medication. The method includes receiving, at the device, an indication of the medication, performing a query of a database, receiving, from the database, a response to the query, the response including information for the medication, processing, at the device, the information for the medication, thereby producing processed information and responsive to the processing, presenting the processed information. In other aspects of the present application, a computer readable medium is provided for adapting a processor in a mobile computing device to carry out this method.

Other aspects and features of the present disclosure will become apparent to those of ordinary skill in the art upon review of the following description of specific implementations of the disclosure in conjunction with the accompanying figures.

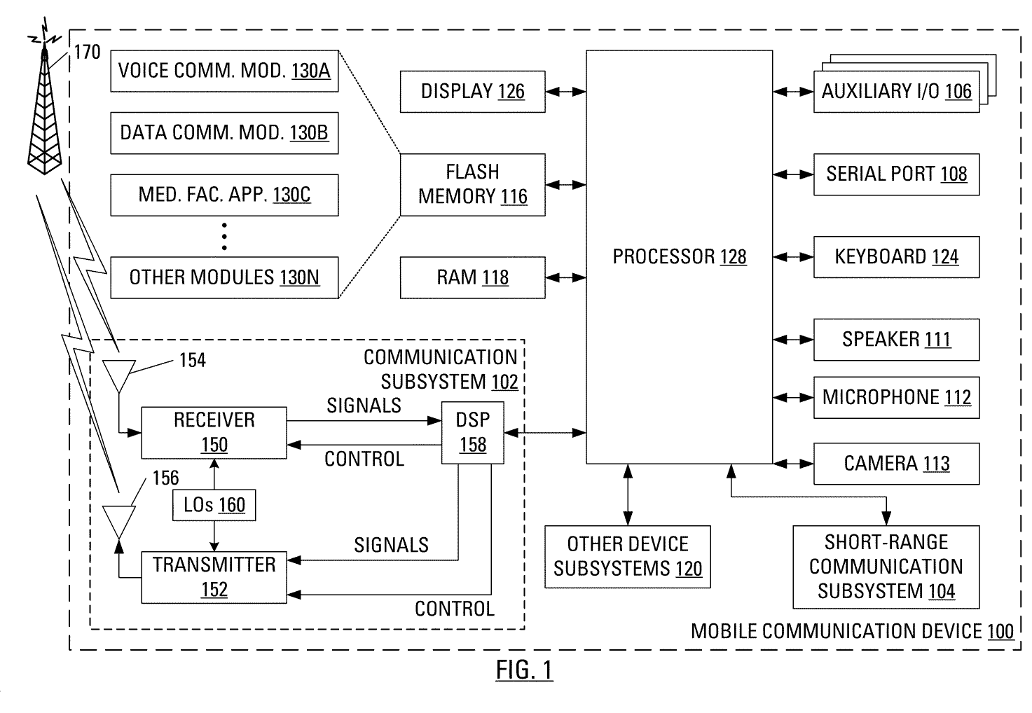

FIG. 1 illustrates a mobile communication device 100 as an example of a device that may carry out methods representative of aspects of the present application. The mobile communication device 100 includes a housing, an input device (e.g., a keyboard 124 having a plurality of keys) and an output device (e.g., a display 126), which may comprise a full graphic, or full color, Liquid Crystal Display (LCD). In some embodiments, the display 126 may comprise a touchscreen display. In such embodiments, the keyboard 124 may comprise a virtual keyboard. Other types of output devices may alternatively be utilized. A processing device (a microprocessor 128) is shown schematically in FIG. 1 as coupled between the keyboard 124 and the display 126. The microprocessor 128 controls the operation of the display 126, as well as the overall operation of the mobile communication device 100, in part, responsive to actuation of the keys on the keyboard 124 by a user.

The housing may be elongated vertically, or may take on other sizes and shapes (including clamshell housing structures). In the case in which the keyboard 124 includes keys that are associated with at least one alphabetic character and at least one numeric character, the keyboard 124 may include a mode selection key, or other hardware or software, for switching between alphabetic entry and numeric entry.

In addition to the microprocessor 128, other parts of the mobile communication device 100 are shown schematically in FIG. 1. These may include a communications subsystem 102, a short-range communications subsystem 104, the keyboard 124 and the display 126. The mobile communication device 100 may further include other input/output devices, such as a set of auxiliary I/O devices 106, a serial port 108, a speaker 111, a microphone 112 and a camera 113. The mobile communication device 100 may further include memory devices including a flash memory 116 and a Random Access Memory (RAM) 118 and various other device subsystems 120. The mobile communication device 100 may comprise a two-way radio frequency (RF) communication device having voice and data communication capabilities. In addition, the mobile communication device 100 may have the capability to communicate with other computer systems via the Internet.

Operating system software executed by the microprocessor 128 may be stored in a computer readable medium, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device may also be stored to the RAM 118.

The microprocessor 128, in addition to its operating system functions, enables execution of software applications on the mobile communication device 100. A predetermined set of software applications that control basic device operations, such as a voice communications module 130A and a data communications module 130B, may be installed on the mobile communication device 100 during manufacture. A medication facilitation application 130C may also be installed on the mobile communication device 100, to implement aspects of the present disclosure. As well, additional software modules, illustrated as an other software module 130N, which may comprise, for instance, a personal information manager (PIM) application, may be installed during manufacture. The PIM application may be capable of organizing and managing data items, such as e-mail messages, calendar events, voice mail messages, appointments and task items. The PIM application may also be capable of sending and receiving data items via a wireless carrier network 170 represented by a radio tower. The data items managed by the PIM application may be seamlessly integrated, synchronized and updated via the wireless carrier network 170 with the device user's corresponding data items stored or associated with a host computer system.

Communication functions, including data and voice communications, are performed through the communication subsystem 102 and, possibly, through the short-range communications subsystem 104. The communication subsystem 102 includes a receiver 150, a transmitter 152 and one or more antennas, illustrated as a receive antenna 154 and a transmit antenna 156. In addition, the communication subsystem 102 also includes a processing module, such as a digital signal processor (DSP) 158, and local oscillators (LOs) 160. The specific design and implementation of the communication subsystem 102 is dependent upon the communication network in which the mobile communication device 100 is intended to operate. For example, the communication subsystem 102 of the mobile communication device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), Enhanced Data rates for GSM Evolution (EDGE), Universal Mobile Telecommunications System (UMTS), Wideband Code Division Multiple Access (W-CDMA), High Speed Packet Access (HSPA), Long Term Evolution (LTE), etc. Other types of data and voice networks, both separate and integrated, may also be utilized with the mobile communication device 100.

Network access requirements vary depending upon the type of communication system. Typically, an identifier is associated with each mobile device that uniquely identifies the mobile device or subscriber to which the mobile device has been assigned. The identifier is unique within a specific network or network technology. For example, in Mobitex™ networks, mobile devices are registered on the network using a Mobitex Access Number (MAN) associated with each device and in DataTAC™ networks, mobile devices are registered on the network using a Logical Link Identifier (LLI) associated with each device. In GPRS networks, however, network access is associated with a subscriber or user of a device. A GPRS device therefore uses a subscriber identity module, commonly referred to as a Subscriber Identity Module (SIM), in order to operate on a GPRS network. Despite identifying a subscriber by SIM, mobile devices within GSM/GPRS networks are uniquely identified using an International Mobile Equipment Identity (IMEI) number.

When required network registration or activation procedures have been completed, the mobile communication device 100 may send and receive communication signals over the wireless carrier network 170. Signals received from the wireless carrier network 170 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the wireless carrier network 170 are processed (e.g., modulated and encoded) by the DSP 158 and are then provided to the transmitter 152 for digital to analog conversion, frequency up conversion, filtering, amplification and transmission to the wireless carrier network 170 (or networks) via the transmit antenna 156.

In addition to processing communication signals, the DSP 158 provides for control of the receiver 150 and the transmitter 152. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 102 and is input to the microprocessor 128. The received signal is then further processed by the microprocessor 128 for output to the display 126, or alternatively to some auxiliary I/O devices 106. A device user may also compose data items, such as e-mail messages, using the keyboard 124 and/or some other auxiliary I/O device 106, such as a touchpad, a rocker switch, a thumb-wheel, a trackball, a touchscreen, or some other type of input device. The composed data items may then be transmitted over the wireless carrier network 170 via the communication subsystem 102.

In a voice communication mode, overall operation of the device is substantially similar to the data communication mode, except that received signals are output to the speaker 111, and signals for transmission are generated by a microphone 112. Alternative voice or audio I/O subsystems, such as a voice message recording subsystem, may also be implemented on the mobile communication device 100. In addition, the display 126 may also be utilized in voice communication mode, for example, to display the identity of a calling party, the duration of a voice call, or other voice call related information.

The short-range communications subsystem 104 enables communication between the mobile communication device 100 and other proximate systems or devices, which need not necessarily be similar devices. For example, the short-range communications subsystem may include an infrared device and associated circuits and components, or a Bluetooth™ communication module to provide for communication with similarly-enabled systems and devices, or a near field communication (NFC) module, etc.

In overview, a method of enhancing patient interaction with medication is proposed herein. Indeed, the enhancement of the patient interaction with medication may be derived from organization, maintenance and presentation of relevant information regarding medication treatment regimes. In one aspect of the present application, the method is implemented by an application (an “app,” i.e., the medication facilitation application 130C) executed on a computing device. The computing device may, for example, take the form and function of the mobile communication device 100 of FIG. 1, which may be colloquially called, for example, a Smartphone. However, it is contemplated that the method may be implemented in many diverse computing environments, such as the computing environment associated with a tablet computer, a phablet, a notebook computer, a desktop computer, a publically available kiosk computer, a pharmacists computer, etc. It is proposed herein to provide information to a patient in an easy-to-read digital format. The information may include, for example, detail in categories such as dosage, contraindications, side effects, overdose treatment and interactions.

To speed transfer of information from medication packaging to a device implementing aspects of the present application, the medication packaging may include encoded information. Such information may be encoded within a standard QR code or barcode and input to the mobile communication device 100 using the camera 113. Alternatively or additionally, the medication packaging may include a Radio Frequency Identification (RFID) tag readable using a NFC feature of the short-range communication subsystem 104 of the mobile communication device 100 implementing aspects of the present application. Alternatively or additionally, the medication packaging may include a display of information rendered in special ink that creates a machine-readable identifier on a package, whether or not the identifier is visible to the naked eye (e.g., capacitive touch ink).

Methods carried out according to aspects of the present application may involve a “setting up” stage. The setting up stage may, for example, involve the creation of a patient profile for an individual patient. In addition to typical patient contact information, such as full name, address and phone numbers, the patient profile may be populated with references to medications and related dosage schedules. The medication reference portion of the patient profile may be populated with references to medications in multiple manners. For example, a patient may capture a digital photograph of a package containing a medication using the camera 113 (see FIG. 1). Additionally or alternatively, the patient's physician may have access to the patient profile and, subsequent to prescribing a medication, the physician may manually input a reference to the prescribed medication and a related dosage schedule.

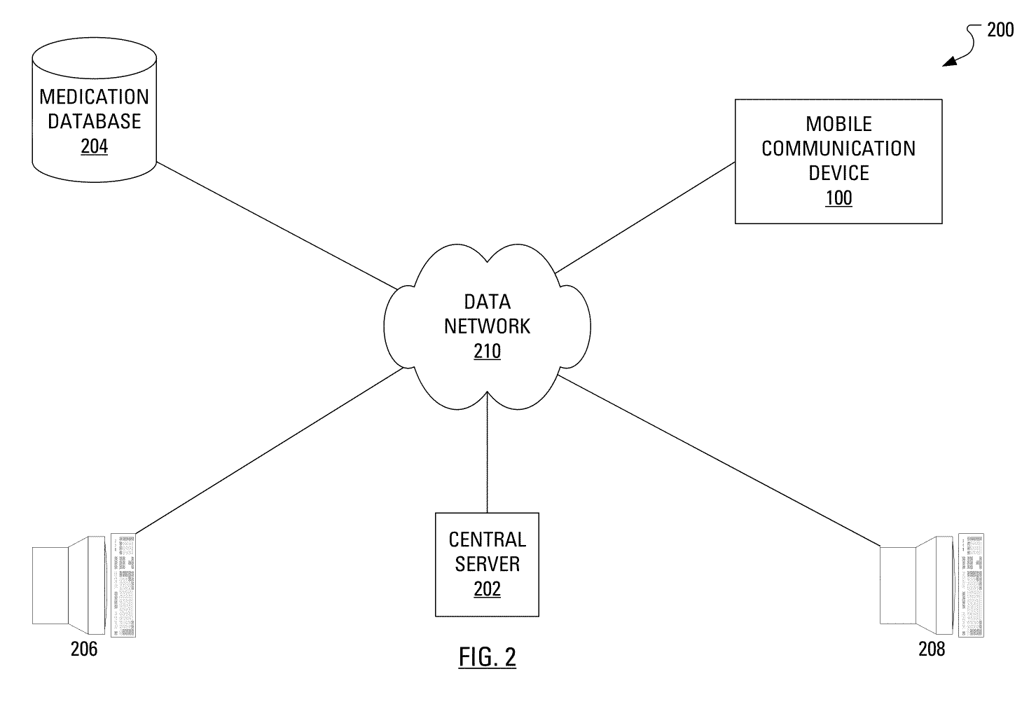

FIG. 2 illustrates an environment 200 in which elements that support aspects of the present application may interact. The elements include, in addition to the mobile communication device 100, a central server 202, a medication database 204, a physician's computer 206 and a pharmacist's computer 208. The various elements of the environment 200 may communication with each other by way of a data network 210. The data network 210 may be implemented in a manner that includes the present-day Internet and successor networks as well as private networks and virtual private networks.

The setting up stage may, for example, further involve the provision of the medication database 204 containing information regarding prescription medications and over-the-counter medications. The medication database 204 may be created by a chain of pharmacies. Alternatively, the medication database 204 may be created by one or more pharmaceutical manufacturers. Copies of the medication database 204 may be stored, in whole or in part, on the mobile communication device 100 in the flash memory 116 or the RAM 118.

The setting up stage may, for example, further involve development and implementation of protocols and processes for communicating patient data over the data network 201 from the mobile communication device 100 to the physician's computer 206 and the pharmacist's computer 208.

Once the setting up stage is sufficiently complete, an “in operation” stage may commence.

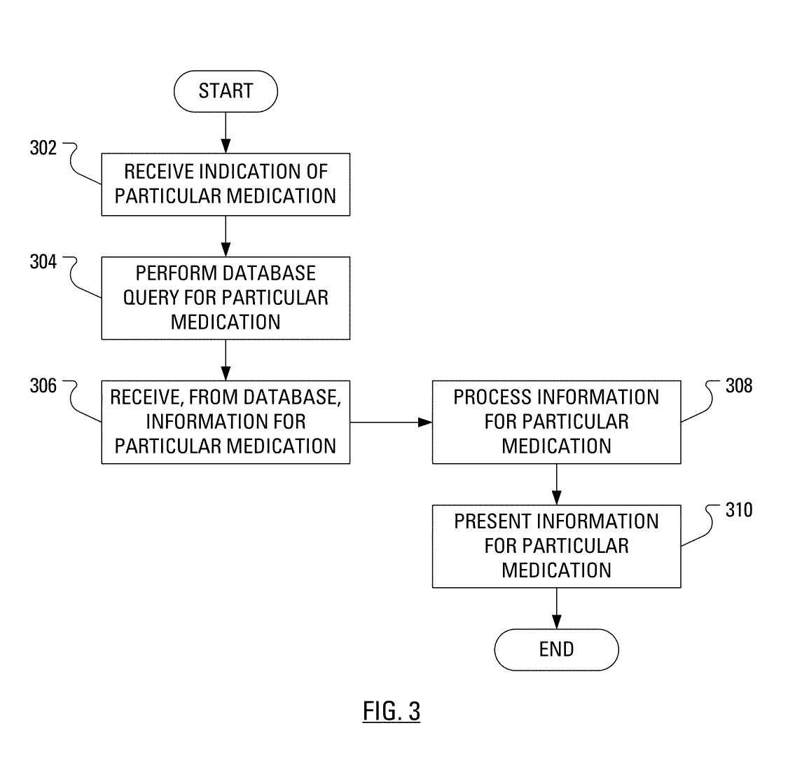

FIG. 3 illustrates example steps in a method of facilitating medication treatment regimes carried out during the in operation stage.

Initially, the microprocessor 128 receives (step 302) input including at least an identification of a particular medication. As discussed hereinbefore, such input may come in the form of a digital image of the particular medication package captured by the camera 113 of the mobile communication device 100. Upon obtaining the image captured by the camera 113, the microprocessor 128 may process the image to obtain the identification of the particular medication. Alternatively, also as discussed hereinbefore, such input may come in the form of a message from the central server 202. The message may, for one example, be received responsive to the physician's computer 206 providing the central server 202 with an indication that the patient has been prescribed the particular medication. The message may, for another example, be received responsive to the pharmacist's computer 208 providing the central server 202 with an indication that the patient has picked up a prescription to the particular medication.

Responsive to receiving (step 302) the input including the identification of the particular medication, the microprocessor 128 may perform (step 304) a query of the database 204. Performing (step 304) the query may involve transmitting a command to the database 204. Depending on the implementation of the database 204, the command may be an SQL command, where SQL is representative of the term “Structured Query Language.” By including the identification of the particular medication, the command may elicit a response from the database 204.

Upon receiving (step 306), from the database 204 responsive to performing (step 304) the query, information for the particular medication, the microprocessor 128 may process (step 308) the information to obtain and record the information most relevant to the patient. Each element of information may be associated with a relevance score. Accordingly, the information most relevant to the patient may be the information for which an associated relevance score surpasses a relevance score threshold.

The processing (step 308) may act to combine the received information for the particular medication with information previously received for other medications and information obtained from the patient, for example, in the set up stage. The processing (step 308) may further act to interact with a calendar application, which may be executed on the same microprocessor 128. The interaction with the calendar application may involve inserting medication dosage reminders.

Upon completing processing (step 308) the information, the microprocessor 128 may present (step 310) a subset of the information to the patient. The nature of the subset of the information that is presented to the patient may be based upon the processing (step 308). Presenting (step 310) the subset of the information to the patient may be accomplished in a number of distinct manners. In one manner, the microprocessor 128 may control the display 126 to present the information as a combination of text and graphics. In another manner, the microprocessor 128 may control the speaker 111 or some other auxiliary I/O device 106 to present the information in an audio format.

The information for the particular medication, that is included in the response from the database 204, may include information that falls into several categories. The categories of information may, for some examples, include dosage, contraindications and side effects.

Information in the dosage category may indicate the size of the prescribed dose. That is, the information may, for example, indicate how much of the medication is to be taken in a single dose. The information may further indicate the timing of the prescribed dose. That is, the information may, for example, indicate when a dose of the medication is to be taken. The information may further indicate the preferred conditions for the prescribed dose. That is, the information may, for example, indicate whether a dose of the medication is to be taken with food, with water or on an empty stomach. The information may further indicate the preferred manner for administering the prescribed dose. That is, the information may indicate whether a dose of the medication is to be: swallowed in pill form; swallowed in liquid form; injected; or inhaled as a mist, for just four examples.

Information in the contraindications category may, for example, indicate: prescription medications that are known to conflict; over-the-counter medications that are known to conflict; medical conditions that are known to contraindicate; that alcohol is known to contraindicate; that recreational drugs are known to contraindicate; that driving and/or operating heavy machinery is to be avoided; that air travel is to be avoided; that sun exposure is to be avoided; and that the medication is not to be taken by those who are pregnant or breastfeeding.

Information in the side effects category may, for example, indicate the nature of normal side effects. The information may also, for example, indicate the nature of abnormal side effects. The information may further, for example, indicate under which circumstances the patient should seek medical treatment for abnormal side effects.

In a first use case, a patient named Kristina likes to know exactly what is in the over-the-counter medications she purchases. After a bad reaction to an over-the-counter cold remedy required her to take a late-night trip to a local emergency ward, Kristina became aware that some over-the-counter medications can have serious side effects and can interact with the prescription medications she is taking.

At her local drug store, Kristina waves a medication package, in particular, a box of a popular pain reliever, over her smartphone. Using, for example, the camera of the smartphone in combination with image recognition software or, simply, QR code interpretation software, the medication facilitation application 130C, executed on Kristina's smartphone in accordance with an aspect of the present application, identifies the medication.

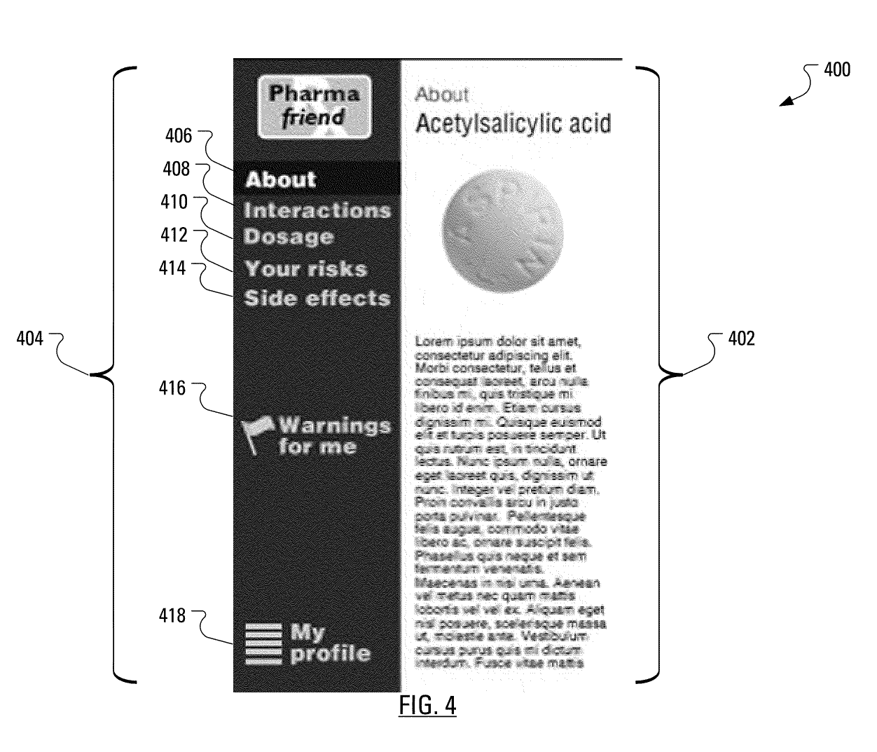

The medication facilitation application 130C, executed on Kristina's smartphone in accordance with an aspect of the present application, receives (step 302) an indication that the medication is the local drug store's private label acetylsalicylic acid (ASA) tablet. Kristina's smartphone may then perform (step 304) a query of the database 204, receive (step 306), from the database 204, information for the medication and process (step 308) the information. Kristina's smartphone may then present (step 310), on the display of the smartphone, information about the medication. The information may be organized into columns under headings such as “INTERACTIONS,” “DOSAGE,” “RISKS” and “SIDE EFFECTS.” Alternatively, as illustrated as a display layout 400 in FIG. 4, the information may be organized in panels for displaying on a dynamic portion 402 of the display layout 400. A control portion 404 of the display layout 400 may include a set of tabs with labels. There may be, for example, an “About” tab 406, an “Interactions” tab 408, a “Dosage” tab 410, a “Your Risks” tab 412 and a “Side effects” tab 414. Furthermore, there may be a “Warnings for me” tab 416 related to personalized warnings. Even further a “My profile” tab 418 may allow viewing and editing of a user profile. Responsive to input from the user on the control portion 404 of the display layout 400, a particular panel may be presented in the dynamic portion 402 of the display layout 400.

The medication facilitation application 130C may be configured to allow Kristina to adjust a number of columns, text size and amount of detail displayed, to better suit her reading requirements. If indicated in a settings portion of the medication facilitation application 130C, the smartphone may present the information in an audio format. The information may be organized to give her the most pertinent facts first, so she can make a decision in the store quickly.

Consider that the medication facilitation application 130C has previously recorded that Kristina takes prescription fluoxetine. In such a scenario, the medication facilitation application 130C, upon processing (step 308) the information, may control the display to present a risk-alerting flag. Such a risk-alerting flag may indicate, to Kristina, that there is a risk that ASA taken in combination with fluoxetine may trigger serious side effects in patients who have been diagnosed with bleeding disorders.

Conveniently, the medication facilitation application 130C may be configured, by Kristina, by her physician or by her pharmacist, with information regarding preexisting conditions (bleeding disorders, Diabetes, hypertension, etc.) or temporary conditions (pregnancy, cold, flu, etc.). In the event that the medication facilitation application 130C has been configured to record that Kristina has a bleeding disorder, the medication facilitation application 130C may be configured to, responsive to the processing (step 308), present (step 310) the risk-alerting flag in a manner that makes the risk-alerting flag more prominent than the risk-alerting flag would be when the medication facilitation application 130C has not been configured to record that Kristina has a bleeding disorder. The medication facilitation application 130C may, for example, present a recommendation that Kristina not purchase or take ASA without approval from her doctor.

In the event that Kristina does not have a bleeding disorder, further to presenting, to Kristina, a display of the information for the medication, the medication facilitation application 130C may also present (step 310), on the display, an alert referencing a promotion from the drug store. The promotion may, for example, relate to a 40 cent reduction in the price of a larger package of the medication that Kristina originally waved over her smartphone. Seeing the opportunity to save some money, Kristina may return the original package of the medication to the shelf and select the larger package size before making her way to the checkout.

In a second use case, a patient named Frank is taking five prescription medications for high blood pressure, acid reflux and arthritis.

Frank also uses over-the-counter medicines for minor issues like headaches and allergy relief. Frank considers it hard to remember to take his medications at the right time. Frank also considers it hard to remember which medications are to be taken on an empty stomach and which medications are be taken with food.

Upon downloading, to his tablet computer, the medication facilitation application 130C, Frank began using the medication facilitation application 130C by waving the boxes of prescription medications in front of his tablet computer. Responsive to the camera or the NFC chip of the tablet computer detecting the code on each of the boxes, microprocessor within the tablet may be considered to have received (step 302) information identifying each medication.

Frank's tablet may then perform (step 304) a query of the database 204, receive (step 306), from the database 204, information for the medications and process (step 308) the information. In addition to presenting (step 310), on the display of the tablet, information about each medication, the processing (step 308) may allow the medication facilitation application 130C to create a dosage schedule for Frank to follow.

It may be that Frank has configured the medication facilitation application 130C with information regarding his regular mealtimes. Based on the regular mealtime information, the medication facilitation application 130C may predict times of day at which Frank is most likely to have an empty stomach. Rather than configuring the medication facilitation application 130C with regular mealtimes, the medication facilitation application 130C may include an interface that allows Frank to indicate when each meal is about to commence. Each day, the medication facilitation application 130C may prompt Frank to take his medication by sounding an alarm and flashing a message on the screen of the tablet. The medication facilitation application 130C may indicate, to Frank as part of the alarm, a quantity of each pill to administer.

Frank may wave each package in front of his tablet and presses a button to register, with the medication facilitation application 130C, that he has administered a dose of the medication he is being prompted to take. The medication facilitation application 130C may be configured to display a friendly face to indicate, to Frank, that he has improved his adherence to his dosage schedule. Indeed, more specifically, the medication facilitation application 130C may be configured to indicate, to Frank, that he has a record of administering the correct medication at the correct time 87 percent of the time.

Frank feels better now that he is taking the correct medication at the right time.

In a third use case, a patient named Anne is taking five prescription medications to treat her arthritis, anxiety and diabetes. Responsive to Anne's tablet having received (step 302) information identifying each medication, Anne's tablet may perform (step 304) a query of the database 204, receive (step 306), from the database 204, information for the medications and process (step 308) the information. In addition to presenting (step 310), on the display of the tablet, typical medication information, the medication facilitation application 130C may display an alert. The alert may, for example, indicate that one of the medication that Anne has been taking for years has been moved to a list of medications that are no longer considered optimally safe for senior citizens. The medication facilitation application 130C may, as part of the processing (step 308) transmit a message to Anne's pharmacist and Anne's doctor with the same alert information.

The medication facilitation application 130C, executed on the tablet and embodying aspects of the present application, may implement a user interface that allows a patient to indicate, to the medication facilitation application 130C, an administering of a dose of a particular medication. For example, the patient may interact with an “I took my dose” button to provide such an indication.

It may be that most of Anne's medications are taken daily and she likes the routine of tapping on the “I took my dose” button each time she takes her medication.

She loves that the medication facilitation application 130C inserts medication dosage reminders into the calendar application of her tablet because she does not have to worry about missing a dose of her medications. If she (or one of her caregivers) thinks that she may have missed a dose, she can quickly bring up a time-stamped record of her dosages just by waving the package in front of her tablet.

One of Anne's medications is an injectable that she has to take on an infrequent basis. She sometimes forgets how to set the dosage on the injectable device and how to administer the prefilled syringe. When she needs to refresh her memory, a tap on a link, presented on the display of her tablet as part of the user interface of the medication facilitation application 130C, may initiate presentation of a video tutorial regarding how to set the dosage on the injectable device and how to administer the prefilled syringe. The video may, for example, have been provided by the pharmaceutical company that made her medication. The video tutorial may be available in a variety of languages, including the language Anne speaks at home.

Before she downloaded the medication facilitation application 130C to her tablet, Anne sometimes forgot to refill her prescriptions on time. The mistake was usually caught by her doctor at the next visit, but it meant Anne had gone without her treatment for several weeks. Since she downloaded the medication facilitation application 130C to her tablet, a reminder from her calendar application indicates when it is time to obtain a refill.

Rather than being generated in the calendar application, the reminder may be generated locally within the medication facilitation application 130C. The local reminder message may, for example, allow Anne to give permission to the medication facilitation application 130C to notify either her physician, or her pharmacy or both that a refill needs to be processed.

Anne likes the information that the medication facilitation application 130C provides her. She feels more confident administering her injectable medication when video help is a tap away. She appreciates not having to worry about whether she took her medication. Furthermore, she likes the refill reminders that prompt her to visit her favorite pharmacy to refill her prescriptions.

Conveniently, the medication facilitation application 130C may communicate medication information, to the patient, in such a manner as to facilitate understanding. For example, a text-to-speech module may allow for label information to be communicated to a patient in an audio format. The patient may opt to trigger playback of a video that illustrates a manner of administering the medication. Furthermore, conveyance of the audio, video and text information may be arranged to be delivered in any of a wide variety of languages.

Also conveniently, aspects of the present application may be shown to increase patient compliance with a given treatment regime for a prescription medication. Responsive to the patient providing information by recording time and dosage amount upon administering a dose, reminders may be set for administering the next dose.

As mentioned hereinbefore, the medication facilitation application 130C may record a date and time responsive to an indication that the patient has taken a dose of a medication. In one example, the patient puts the mobile communication device 100 over a medication package. Responsively, the microprocessor 128 may control the user interface to display a question such as “Do you want to record a dose of this medication at this time?”

The medication facilitation application 130C may, when appropriate, provide a “Time to take medication” reminder. Alternatively, through the medication facilitation application 130C interacting with a calendar application, the calendar application may provide the patient with reminders. Such reminders may extend beyond dosage timing and prompt the patient to initiate a refill process. Alternatively, the medication facilitation application 130C may communicate with a physician and/or a pharmacy and automate the refill process.

Aspects of the present application may be shown to strengthen brand awareness and, thereby, combat a threat, perceived by innovating pharmaceutical companies, that generic medications may displace long-established brands.

Aspects of the present application may be shown to protect patient safety. In particular, contraindicated medications that the patient is already taking may be flagged. Furthermore, counterfeiting of medications may be reduced. Further still, an image, e.g., a photograph, of the dose (e.g., a tablet or a capsule) may be displayed for review by the patient and, consequently, may assist to reduce a risk of confusion.

Aspects of the present application may involve integration with social media. Furthermore, aspects of the present application may allow for integration with a discussion forum for patients taking a particular medication or living with a particular condition.

Aspects of the present application may be related to regulatory compliance. That is, a portion of the data presented to the user for a particular medication may be useful in proving regulatory compliance on the part of the pharmaceutical firm that markets the particular medication.

Known dosage recording systems require battery-operated pill bottles or blister packages printed with circuits made of conductive ink. Inconveniently, known systems for patient-to-physician communications often require a proprietary connection to a personal computer or a cellular device embedded in a medication package.

It should be clear that aspects of the application proposed herein rely on various types of data, primarily medication data and patient data. The medication data may be public or may be proprietary to the pharmaceutical manufacturer. Accordingly, managing privacy for the medication data may be relatively simple. In contrast, managing privacy concerns for the patient data may be relatively complex.

At one point in a privacy spectrum, a profile portion of the patient data is maintained on the device on which the application is executed. Indeed, the profile portion of the patient data may be encrypted on the device. Of course, not all patient data is best left immune to sharing. For patient safety purposes, prescription data may be shared with the patient's prescribing physicians or dispensing pharmacies. Rather than, or in addition to, storing patient data on the device, patient data may also be stored in networked storage facilities, also known as “the cloud.” While cloud-stored data may be encrypted and maintained with a privacy equal to the privacy associated with on-device storage, there is known to be a general unease associated with cloud storage of personal data.

At another point in the privacy spectrum, patient data may be partially public and partially private. This would enable patients to selectively share identifying or semi-identifying (first name, location and medications taken) information with a group on Facebook™ or other, similar social media network. Such selective sharing may be seen to facilitate participation in a support group for disease sufferers. The panel presented in the dynamic portion 402 of the display layout 400 responsive to input on the My profile tab 418 of the control portion 404 of the display layout 400 may, for example, allow the patient to control sharing of particular information in a relevant group. The patient may also identify the information that shall remain private.

At still another point in the privacy spectrum, patient data may be made anonymous before being shared. In this example, a patient may opt to share data that has been stripped of identifying information with a pharmacy or the manufacturer of the medication for commercial, not treatment purposes. Such anonymous, shared information might be valuable to pharmacies or pharmaceutical companies because the anonymous, shared information may be analyzed to yield information about purchase or prescription renewal rates and habits, adherence to dosage schedules, etc. Interested parties (pharmacies or pharmaceutical companies) may encourage patients to select the anonymous sharing option by compensating patients for providing access to this data. The encouragement or compensation may take the form of coupons or loyalty points, for only two examples.

The above-described implementations of the present application are intended to be examples only. Alterations, modifications and variations may be effected to the particular implementations by those skilled in the art without departing from the scope of the application, which is defined by the claims appended hereto.

What is claimed is:

1. A method of facilitating, at a device, a regime for administering of a medication, the method comprising:
receiving, at the device, an indication of the medication;
performing a query of a database;
receiving, from the database, a response to the query, the response including information for the medication;
processing, at the device, the information for the medication, thereby producing processed information; and
responsive to the processing, presenting the processed information.

2. The method of claim 1 wherein the presenting comprises controlling a display on the device to textually convey the processed information.

3. The method of claim 1 wherein the presenting comprises controlling a speaker on the device to audibly convey the processed information.

4. The method of claim 1 wherein the receiving comprises receiving using a near field communication protocol.

5. The method of claim 1 wherein the receiving comprises:
obtaining an image; and
processing the image to obtain the indication of the medication.

6. The method of claim 1 wherein the receiving comprises receiving a message from a central server.

7. The method of claim 1 wherein the performing the query comprises transmitting a command to the database.

8. The method of claim 7 wherein the command comprises a Structured Query Language command.

9. The method of claim 1 wherein the processed information comprises information elements associated with an relevance score that surpasses a relevance score threshold.

10. The method of claim 1 further comprising:
receiving patient information in a set up stage; and
wherein the processing comprises combining the received information for the medication with the patient information.

11. The method of claim 1 further comprising interacting with a calendar application to insert medication dosage reminders.

12. The method of claim 1 wherein presenting the processed information comprises presenting an alert.

13. The method of claim 12 wherein the alert comprises a medication contraindication alert.

14. The method of claim 12 wherein the medication contraindication alert relates to the age of the patient.

15. The method of claim 12 wherein the medication contraindication alert relates to a second medication associated with the patient.

16. A computer readable medium having stored thereon computer executable instructions, the computer executable instructions comprising code that, upon execution by a processor in an electronic device, causes the processor to:
receive an indication of the medication;
perform a query of a database;
receive, from the database, a response to the query, the response including information for the medication;
process the information for the medication, thereby producing processed information; and
present the processed information.
